(19) United States
(12) Patent Application Publication
(10) Pub. No.: US 2022/0089147 A1
(43) Pub. Date: Mar. 24, 2022

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Takaharu UENO, Nagoya-shi (JP); Kenichi YAMADA, Nisshin-shi (JP); Ryosuke KOBAYASHI, Nagakute-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/396,852

(22) Filed: Aug. 9, 2021

(30) Foreign Application Priority Data
Sep. 23, 2020 (JP) 2020-158212

(51) Int. Cl. B60W 30/06; B60W 60/00; G08G 1/14

(52) U.S. Cl. CPC B60W 30/06; B60W 2420/42; G08G 1/148; B60W 60/001

(57) ABSTRACT

A vehicle waiting to park is guided to a parking slot having a sign of movement of a parked vehicle. A controller is provided that performs: obtaining information for associating a parking slot in which a user has parked with the user; obtaining information about a sign of the user returning to the parking slot; and making another user waiting to park aware of a position of the parking slot when the user obtains the information about the sign of the user returning to the parking slot.

### CROSS REFERENCE TO THE RELATED APPLICATION

This application claims the benefit of Japanese Patent Application No. 2020-158212, filed on Sep. 23, 2020, which is hereby incorporated by reference herein in its entirety.

### BACKGROUND

### Technical Field

The present disclosure relates to an information processing apparatus, an information processing method, and a system.

### Description of the Related Art

There has been known a technology that grasps the parking status of a vehicle in a parking slot, and notifies a terminal of a user of a vacant state (availability) of the parking slot (see, for example, Patent Literature 1). In this technology, past parking information is stored in a database, so that information is provided to users about parking slots that are likely to be available.

### CITATION LIST

### Patent Literature

Patent Literature 1: Japanese Patent Application Laid-Open Publication No. 2020-098529

### SUMMARY

Even if parking slots that are likely to be available are predicted based on past information, it does not necessarily mean that the parking slots will actually be available. An object of the present disclosure is to guide a vehicle waiting to park to a parking slot having a sign of movement of a parked vehicle.

One aspect of the present disclosure is directed to an information processing apparatus including a controller configured to perform:

obtaining information for associating a parking slot in which a user has parked with the user;

obtaining information about a sign of the user returning to the parking slot; and

making another user waiting to park aware of a position of the parking slot when the user obtains the information about the sign of the user returning to the parking slot.

Another aspect of the present disclosure is directed to an information processing method for causing a computer to perform:

obtaining information for associating a parking slot in which a user has parked with the user;

obtaining information about a sign of the user returning to the parking slot; and

making another user waiting to park aware of a position of the parking slot when the user obtains the information about the sign of the user returning to the parking slot.

A further aspect of the present disclosure is directed to a system comprising:

a first transmission unit configured to transmit a parking slot in which a user has parked and the user in association with each other;

a second transmission unit configured to transmit information about a sign of the user returning to the parking slot; and

a controller configured to make another user waiting to park aware of a position of the parking slot based on information received from the first transmission unit and the second transmission unit.

A still further aspect of the present disclosure is directed to a program for causing a computer to execute the above-described method, or a computer readable storage medium in which the program is stored in a non-transitory manner.

According to the present disclosure, it is possible to guide a vehicle waiting to park to a parking slot where there is a sign of movement of a parked vehicle.

### BRIEF DESCRIPTION OF THE DRAWINGS

FIG. 1 is a view illustrating a schematic configuration of a system according to an embodiment;

FIG. 2 is a view illustrating an outline of a store and a parking lot;

FIG. 3 is a block diagram schematically illustrating an example of a configuration of each of a drone, a user terminal, a server, and a vehicle, which together constitute the system according to a first embodiment;

FIG. 4 is a diagram illustrating a functional configuration of the drone;

FIG. 5 is a diagram illustrating an example of a functional configuration of the server;

FIG. 6 is a diagram illustrating an example of a table structure of an alighting information DB;

FIG. 7 is a diagram illustrating an example of a functional configuration of the user terminal;

FIG. 8 is a sequence diagram of processing of the system according to the first embodiment;

FIG. 9 is a flowchart of processing in the server according to the first embodiment;

FIG. 10 is a flowchart of processing of guiding a second vehicle by the drone according to the first embodiment;

FIG. 11 is a flowchart of processing of generating alighting information in the drone according to the first embodiment;

FIG. 12 is a flowchart of processing for generating exit information in the drone according to the first embodiment;

FIG. 13 is a flowchart of processing in the user terminal according to the first embodiment;

FIG. 14 is a view illustrating an outline of a store and a parking lot according to a second embodiment;

FIG. 15 is a block diagram schematically illustrating an example of a configuration of each of a first payment machine, a second payment machine and a gate, which together constitute a system according to the second embodiment;

FIG. 16 is a sequence diagram of processing of the system according to the second embodiment;

FIG. 17 is a diagram illustrating an example of a table structure of an alighting information DB according to the second embodiment;

FIG. 18 is another sequence diagram of processing of the system according to the second embodiment;

FIG. 19 is a flowchart of processing in a server according to the second embodiment; and

FIG. 20 is a view illustrating an outline of a store and a parking lot according to a third embodiment.

### DESCRIPTION OF THE EMBODIMENTS

An information processing apparatus, which is one aspect of the present disclosure, includes a controller configured to perform: obtaining information about a parking slot in which a user has parked; obtaining information about a sign of the user returning to the parking slot; and making another user waiting to park aware of the position of the parking slot when the user obtains the information about the sign of the user returning to the parking slot. The information about the parking slot in which the user has parked is, for example, information associating the user with the parking slot, and is, for example, information including information about the user and information capable of specifying the parking slot. The information about the user may be, for example, information capable of specifying the user who has parked. The information about the user is, for example, an image obtained by photographing the face of the user, identification information of a terminal used by the user, a credit card used by the user, identification information of a beacon lent to the user, or the like. The information capable of specifying the parking slot is, for example, position information of the parking slot or information about an identification number of the parking slot.

The sign of the user returning to the parking slot may be, for example, a sign that the user is about to restart the parked vehicle. For example, the fact that the user has made a payment at a cash register, the fact that the user has left a store, the fact that the user is moving toward the parking lot along a path leading to the parking lot or the like can be mentioned as the sign of the user returning to the parking slot.

When information about the sign of the user returning to the parking slot is obtained, it can be predicted that the parking slot will become vacant or available in the near future. Therefore, the controller outputs information for making another user waiting to park aware of the position of the parking slot. This information is, for example, information for causing a drone to hover above the parking slot, illuminating the parking slot with a light, turning on a lamp provided in the parking slot, turning on a hazard lamp of a vehicle parked in the parking slot, or the like. Note that in addition to another user waiting to park, the user returning to the parking slot may be made aware of the position of the parking slot.

In this way, it is possible to improve the accuracy of the prediction that the parking slot will become vacant, thus making it possible to quickly guide the vehicle of another user to the parking slot that will become vacant.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

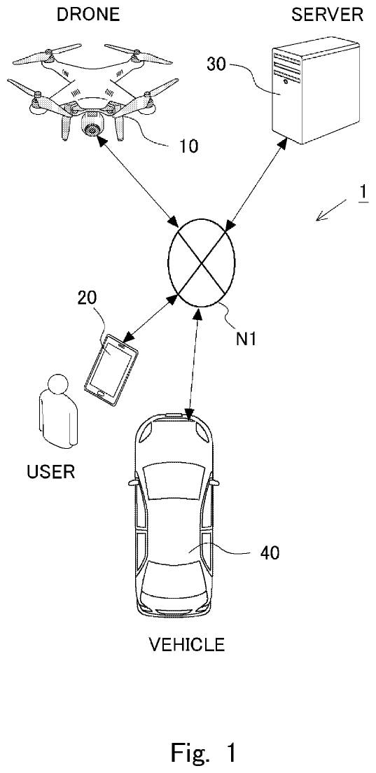

FIG. 1 is a view illustrating a schematic configuration of a system 1 according to a first embodiment. The system 1 is a system that notifies other users of the position (or location) of a parking slot (or space) in which a user is parked as the position of a parking slot that is likely to be vacant in the near future, when the user who parked a vehicle in a parking lot provided in a store is predicted to leave or exit the store.

In the example of FIG. 1, the system 1 includes a drone 10, a user terminal 20, a server 30, and a vehicle 40. The drone 10, the user terminal 20, the server 30, and the vehicle 40 are connected to one another by means of a network N1. The drone 10 is capable of moving autonomously. The user terminal 20 is a terminal that is used by the user. The vehicle 40 is a vehicle in which a user rides. The vehicle 40 may be a vehicle that is manually driven by the user or a vehicle that autonomously travels.

The network N1 is, for example, a worldwide public communication network such as the Internet or the like, and a WAN (Wide Area Network) or other communication networks may be adopted. Also, the network N1 may include a telephone communication network such as a mobile phone network or the like, or a wireless communication network such as Wi-Fi (registered trademark) or the like. Here, note that FIG. 1 illustrates one drone 10, one user terminal 20, and one vehicle 40 as an example, but there can be a plurality of drones 10, user terminals 20, and vehicles 40.

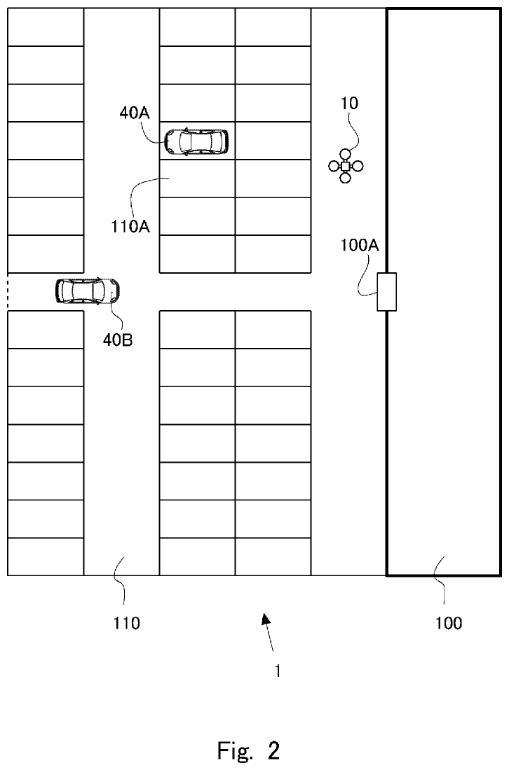

FIG. 2 is a view illustrating an outline of a store 100 and a parking lot 110. The parking lot 110 is attached to the store 100. The parking lot 110 is provided with a plurality of parking slots (or spaces) 110A. One vehicle 40 can be parked in each parking slot 110A. In FIG. 2, a vehicle 40 already parked is referred to as a first vehicle 40A, and a vehicle 40 waiting for a parking slot 110A to become vacant or available is referred to as a second vehicle 40B. The drone 10 flies over the parking lot 110. The store 100 has a doorway 100A, and users go back and forth between the store 100 and the parking lot 110 through the doorway 100A. Here, note that in FIG. 2, only one first vehicle 40A is illustrated, but other first vehicles 40A are also parked in the other parking slots 110A, and the illustration of the other first vehicles 40A is omitted. The parking lot 110 illustrated in FIG. 2 is in a state close to full. The processing of guiding the second vehicle 40B to a parking slot 110A described below may be activated only when the parking lot 110 is close to full.

The drone 10 is equipped with a camera, which takes an image of the face of a user who has alighted from (gotten off) a first vehicle 40A parked in a parking slot 110A (hereinafter referred to as a first user), so that the image is transmitted to the server 30 along with the position information. At this time, the image of the face of the first user is associated with the position of the first vehicle 40A and the position of the parking slot 110A. Also, the drone 10 takes an image of each user coming out of the store 100 through the doorway 100A, and transmits the image to the server 30. The server 30 compares the image of the face of the user coming out of the store 100 with the image of the face of the user getting off the first vehicle 40A to specify the position of the parking slot 110A where the user coming out of the store 100 has parked. The position information of the parking slot 110A specified in this manner is transmitted to the user terminal 20 of the user riding in the second vehicle 40B (hereinafter, also referred to as a second user) or to the second vehicle 40B. This enables the second user to know the position of the parking slot 110A that is likely to be vacant. Note that, hereinafter, the user terminal 20 carried by the first user is also referred to as a first user terminal 20A, and the user terminal 20 carried by the second user is also referred to as a second user terminal 20B. In cases where the first user terminal 20A and the second user terminal 20B are not distinguished from each other, the first user terminal LA and the second user terminal LA are simply referred to as user terminals 20.

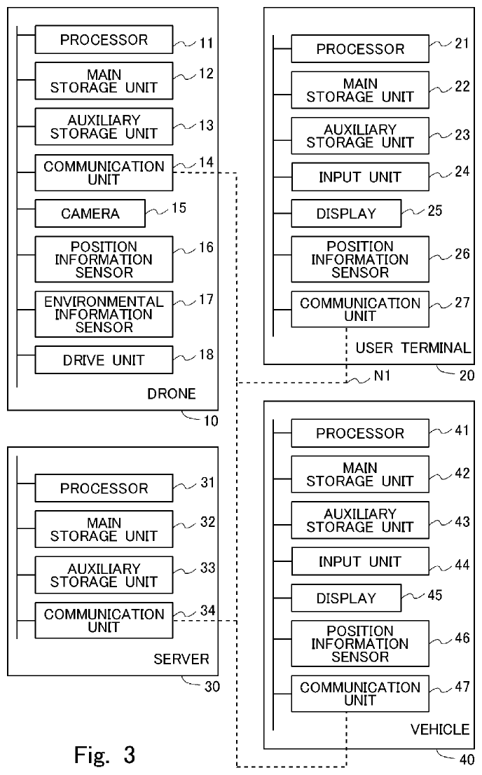

The hardware configurations and functional configurations of the drone 10, the user terminal 20, the server 30, and the vehicle 40 will be described based on FIG. 3. FIG. 3 is a block diagram schematically illustrating one example of the configuration of each of the drone 10, the user terminal 20, the server 30 and the vehicle 40, which together constitute the system 1 according to the present embodiment.

The server 30 has a configuration of a general computer. The server 30 includes a processor 31, a main storage unit 32, an auxiliary storage unit 33, and a communication unit 34. These components are connected to one another by means of a bus. The processor 31 is an example of a controller.

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. As a result, the server 30 realizes functions that match predetermined purposes. The main storage unit 32 and the auxiliary storage unit 33 are computer readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33. In the auxiliary storage unit 33, for example, information about a parking waiting state (hereinafter, also referred to as parking waiting information) entered or inputted to the user terminal 20 by the user has been stored in association with a user ID.

The communication unit 34 is a means or unit that communicates with the drone 10, the user terminal 20, and the vehicle 40 via the network N1. The communication unit 34 is, for example, a LAN (Local Area Network) interface board, a wireless communication circuit for wireless communication, or the like. The LAN interface board and the wireless communication circuit are connected to the network N1.

Next, the drone 10 is a moving object capable of autonomously flying based on a command received from the server 30. The drone 10 is, for example, a multicopter. The drone 10 includes a processor 11, a main storage unit 12, an auxiliary storage unit 13, a communication unit 14, a camera 15, a position information sensor 16, an environmental information sensor 17, and a drive unit 18. These components are connected to one another by means of a bus. The processor 11, the main storage unit 12, and the auxiliary storage unit 13 are the same as the processor 31, the main storage unit 32, and the auxiliary storage unit 33 of the server 30, respectively, and hence, the description thereof will be omitted. Note that the drone 10 is an example of a first transmission unit and a second transmission unit.

The communication unit 14 is a communication means or unit for connecting the drone 10 to the network N1. The communication unit 14 is a circuit for performing communication with other devices (e.g., the user terminal 20, the server 30, the vehicle 40, and so on) via the network N1 by making use of a mobile communication service (e.g., a telephone communication network such as 5G (5th Generation), 4G (4th Generation), 3G (3rd Generation), LTE (Long Term Evolution) or the like), wireless communication such as Wi-Fi (registered trademark), Bluetooth (registered trademark), RFID (Radio Frequency Identification), or the like.

The camera 15 is a device that takes images of an area around the drone 10. The camera 15 takes images by using an imaging element such as a CCD (Charge Coupled Device) image sensor, a CMOS (Complementary Metal Oxide Semiconductor) image sensor or the like. The images obtained by photographing may be either still images or moving images.

The position information sensor 16 obtains position information (e.g., latitude and longitude) of the drone 10 at predetermined intervals. The position information sensor 16 is, for example, a GPS (Global Positioning System) receiver unit, a wireless communication unit or the like. The information obtained by the position information sensor 16 is recorded, for example, in the auxiliary storage unit 13 or the like and transmitted to the server 30.

The environmental information sensor 17 is a means or unit for sensing the state of the drone 10 or sensing the area around the drone 10. As an example of the sensor for sensing the state of the drone 10, there is mentioned a gyro sensor, an acceleration sensor, an azimuth sensor, or the like. Also, as an example of the sensor for sensing the area around the drone 10, there is mentioned a stereo camera, a laser scanner, a LIDAR, a radar, or the like. The camera 15 as described above can also be used as the environmental information sensor 17. The data obtained by the environmental information sensor 17 is also referred to as “environmental data”.

The drive unit 18 is a device for flying the drone 10 based on a control command generated by the processor 11. The drive unit 18 is configured to include, for example, a plurality of motors or the like for driving rotors included in the drone 10, so that the plurality of motors or the like are driven in accordance with the control command, thereby to achieve the autonomous flight of the drone 10.

Now, the user terminal 20 will be described. The user terminal 20 is a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, a position information sensor 26, and a communication unit 27. These components are connected to one another by means of a bus. The processor 21, the main storage unit 22 and the auxiliary storage unit 23 are the same as the processor 31, the main storage unit 32 and the auxiliary storage unit 33 of the server 30, respectively, and hence, the description thereof will be omitted. In addition, the position information sensor 26 is the same as the position information sensor 16 of the drone 10. The information obtained by the position information sensor 26 is recorded, for example, in the auxiliary storage unit 23 or the like, and transmitted to the server 30.

The input unit 24 is a means or unit that receives an input operation performed by the user, and is, for example, a touch panel, a mouse, a keyboard, a push button, or the like. The display 25 is a means or unit for presenting information to the user, and is, for example, an LCD (Liquid Crystal Display), an EL (Electroluminescence) panel, or the like. The input unit 24 and the display 25 may be configured as a single touch panel display. The communication unit 27 is a communication means or unit for connecting the user terminal 20 to the network N1. The communication unit 27 is a circuit for communicating with other devices (e.g., the drone 10, the server 30, the vehicle 40 and so on) via the network N1 by making use of a mobile communication service (e.g., a telephone communication network such as 5G (5th Generation), 4G (4th Generation), 3G (3rd Generation), LTE (Long Term Evolution) or the like), or a wireless communication network such as Wi-Fi (registered trademark), Bluetooth (registered trademark) or the like.

Then, the vehicle 40 includes a processor 41, a main storage unit 42, an auxiliary storage unit 43, an input unit 44, a display 45, a position information sensor 46, and a communication unit 47. These components are connected to one another by means of a bus. The processor 41, the main storage unit 42, the auxiliary storage unit 43, the input unit 44, the display 45, the position information sensor 46, and the communication unit 47 are the same as the processor 21, the main storage unit 22, the auxiliary storage unit 23, the input unit 24, the display 25, the position information sensor 26, and the communication unit 27 of the user terminal 20, respectively, and thus the description thereof will be omitted.

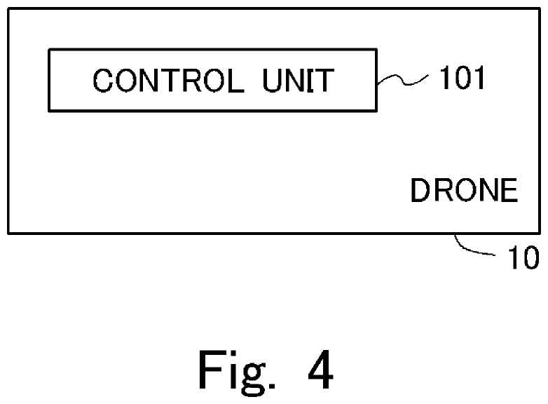

Next, the functions of the drone 10 will be described. FIG. 4 is a diagram illustrating a functional configuration of the drone 10. The drone 10 includes a control unit 101 as its functional component. The processor 11 of the drone 10 executes the processing of the control unit 101 by a computer program on the main storage unit 12. However, a part or all of the processing of the control unit 101 may be executed by a hardware circuit, or may be executed by another or other computers connected to the network N1.

The control unit 101 controls autonomous flight of the drone 10. The control unit 101 generates a control command for controlling the drive unit 18 by using the environmental data detected by the environmental information sensor 17. The control unit 101 controls, for example, the ascent, descent, forward movement, backward movement, turning and the like of the drone 10 by controlling the plurality of motors to generate differences in rotation speed between the plurality of rotors.

The control unit 101 generates, for example, a flight trajectory of the drone 10 based on the environmental data, and controls the drive unit 18 so that the drone 10 can fly along the flight trajectory. Here, note that as a method of causing the drone 10 to fly in an autonomous manner, there can be adopted a known method. The control unit 101 may perform feedback control based on a detected value of the environmental information sensor 17 during the autonomous flight of the drone 10.

In addition, the control unit 101 determines a vehicle 40 to be parked in a parking slot 110A by image analysis, and takes an image of the face of a user getting off the parked vehicle 40. Then, the image of the face of the user is transmitted to the server 30 in association with the position information of the parking slot 110A. The position information of the parking slot 110A may be any information as long as the position of the parking slot 110A can be specified, and may be, for example, the position information of the drone 10. Also, as another method, in cases where an identification number is described on the parking slot 110A, this identification number may be photographed. The identification number thus photographed is recognized by image analysis of the server 30, so that the position of the parking slot 110A is specified. In this manner, the position where the vehicle 40 of the user is parked and the face of the user are associated with each other. In the present embodiment, the face of the user is photographed, but the present invention is not limited to this, and it is also possible to photograph, for example, the stature, height, size or the like of the user that can identify the user. The information that the control unit 101 transmits to the server 30 when the user gets off the vehicle is hereinafter referred to as “alighting information”.

Moreover, the control unit 101 takes an image of the face of the user coming out from the store 100 through the doorway 100A, and transmits the image thus taken to the server 30. The information transmitted by the control unit 101 to the server 30 when the user leaves the store is hereinafter referred to as “exit information”.

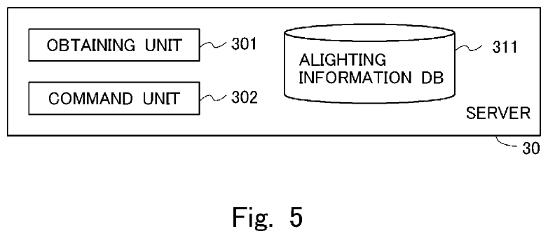

Then, the functions of the server 30 will be described. FIG. 5 is a diagram illustrating an example of a functional configuration of the server 30. The server includes, as its functional components, an obtaining unit 301, a command unit 302, and an alighting information DB 311. The processor 31 of the server 30 performs the processing of the obtaining unit 301 and the command unit 302 by executing a computer program on the main storage unit 32. However, any of the individual functional components or a part of the processing thereof may be implemented by a hardware circuit.

The alighting information DB 311 is built by a program of a database management system (DBMS) that is executed by the processor 31 to manage data stored in the auxiliary storage unit 33. The alighting information DB 311 is, for example, a relational database.

Here, note that any of the individual functional components of the server 30 or a part of the processing thereof may be executed by another computer connected to the network N1.

The obtaining unit 301 obtains alighting information and exit information from the drone 10. The obtaining unit 301 stores the alighting information thus obtained in the alighting information DB 311.

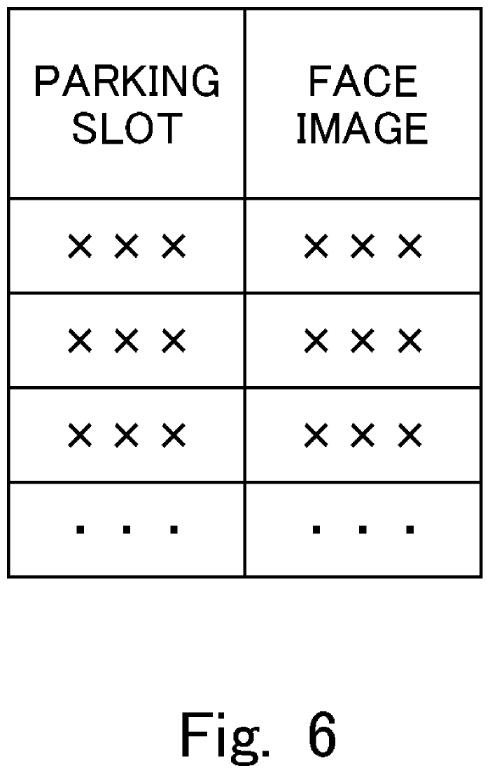

Here, the structure or configuration of the alighting information stored in the alighting information DB 311 will be described based on FIG. 6. FIG. 6 illustrates an example of a table structure of the alighting information DB 311. The alighting information table includes fields for parking slot and face image, respectively. The parking slot field is a field in which information capable of specifying the position of each parking slot is entered. In the parking slot field, for example, position information of the drone 10 transmitted from the drone 10 is entered. The face image field is a field in which an image of the face of a first user is entered. Note that, in the face image field, information about a storage location of the image or identification information of the image may be entered.

Then, the command unit 302 specifies the position of the parking slot 110A where the first user who left the store has parked, based on the alighting information stored in the alighting information DB 311 and the exit information obtained from the drone 10. Hereinafter, the parking slot 110A where the first user has parked is referred to as a first parking slot 111A. The command unit 302 compares the face image included in the exit information with each face image stored in the face image field of the alighting information DB 311, thereby to extract a record in which the faces match each other. The position of the parking slot 110A is obtained from the parking slot field included in the record. The parking slot 110A obtained in this manner is a parking slot that is predicted to become vacant in the near future. In this way, the command unit 302 predicts the parking slot 110A that will be available in the near future.

The command unit 302 transmits the information about the first parking slot 111A to a second user terminal 20B of a second user riding in a second vehicle 40B. Here, note that in the present embodiment, the information about the first parking slot 111A is transmitted to the second user terminal 20B, but alternatively, the information about the first parking slot 111A may be transmitted to the second vehicle 40B. Here, note that the information about the first parking slot 111A is transmitted to the second user terminal 20B or the second vehicle 40B that has transmitted parking waiting information to be described later. In the second user terminal 20B, information about the first parking slot 111A is displayed on the display 25. The command unit 302 may transmit to the second user terminal 20B, for example, position information of the first parking slot 111A or map information of the parking lot indicating the position of the first parking slot 111A. Also, alternatively, the command unit 302 may generate a route to the first parking slot 111A based on the position information of the second user terminal 20B or the second vehicle 40B and the position information of the first parking slot 111A, and transmit the route to the second user terminal 20B or the second vehicle 40B.

Here, note that as another method, the position of the first parking slot 111A may be notified to the second user by illuminating the first parking slot 111A with a light included in the drone 10 or a light installed in each parking slot 110A. By illuminating the first parking slot 111A with the light in this manner, the first user can also easily recognize the position of the first parking slot 111A, and thus can more quickly start the first vehicle 40A. The command unit 302, for example, generates a command to the drone 10 to move to the first parking slot 111A and to illuminate the first parking slot 111A after moving, and transmits the command thus generated to the drone 10. Also, the command unit 302 specifies a light corresponding to the first parking slot 111A, generates a command to turn on the light specified, and transmits the command generated to a controller that controls the light. Note that in cases where a plurality of drones 10 are present, for example, an optional drone may be selected, or a drone 10 having the shortest distance from the first parking slot 111A may be selected based on the position information of the drone 10 and the position information of the first parking slot 111A. In addition, the drone 10 having the largest amount of charge may be selected.

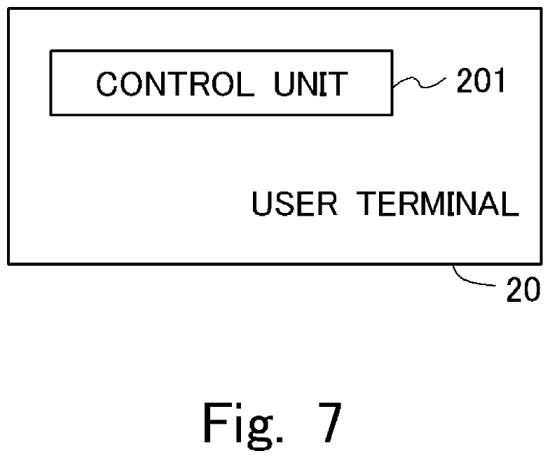

Now, the functions of the user terminal 20 will be described. FIG. 7 is a diagram illustrating an example of a functional configuration of the user terminal 20. The user terminal 20 includes a control unit 201 as its functional component. The processor 21 of the user terminal 20 executes the processing of the control unit 201 by a computer program on the main storage unit 22. The control unit 201 executes, for example, application software for notifying the position of each parking slot 110A. The user enters, for example, that he or she is waiting to park (hereinafter referred to as a parking waiting state) into the user terminal 20 via the input unit 24. The control unit 201 transmits information about the parking waiting state (hereinafter also referred to as parking waiting information) entered by the user to the server 30 in association with the user ID. The user ID may be identification information of the user terminal 20.

Further, upon receiving the information about the position of the first parking slot 111A from the server 30, the control unit 201 displays on the display 25 an image corresponding to the information about the position of the first parking slot 111A. For example, the control unit 201 displays on the display 25 the number of the first parking slot 111A, a map showing the position of the first parking slot 111A within the parking lot 110, or the route to the first parking slot 111A.

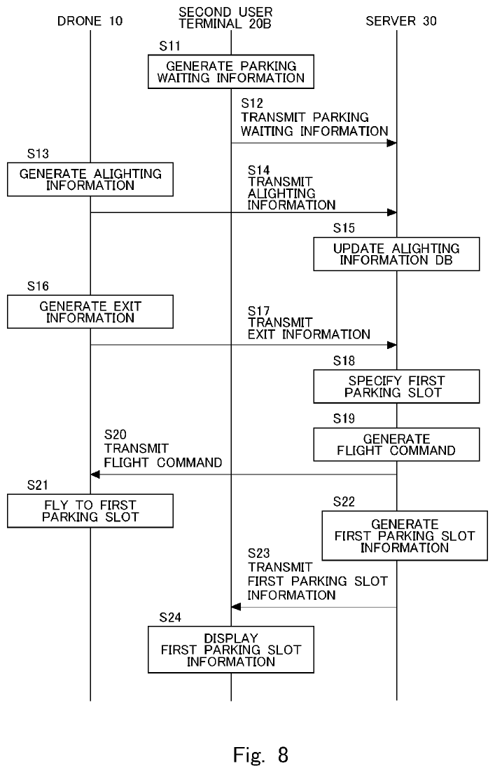

Now, the processing of the system 1 as a whole will be described. FIG. 8 is a sequence diagram of the processing of the system 1. In FIG. 8, first, parking waiting information is generated in the second user terminal 20B (S11). For example, when the second user makes a predetermined input to the second user terminal 20B, the second user terminal 20B may be triggered to generate parking waiting information. The trigger for generating the parking waiting information is not limited to this, but may be, for example, that the vehicle 40 is driving in a lane that enters the parking lot 110, or that the vehicle 40 has passed an entrance of the parking lot 110. Then, the parking waiting information thus generated is transmitted from the second user terminal 20B to the server 30 (S12). Note that even in the middle of the processing in and after the following step S13, parking waiting information is transmitted to the server 30 each time there occurs a vehicle 40 waiting to park. Also, in FIG. 8, the parking waiting information is generated in the second user terminal 20B, but alternatively, the parking waiting information may be generated in the second vehicle 40B. In this case, the second user makes the predetermined input to the input unit 44 of the second vehicle 40B, for example.

Subsequently, when the vehicle 40 is parked in a parking slot 110A, the drone 10 takes an image of the alighting user and obtains position information thereof, thereby generating alighting information based on these pieces of information (S13). The alighting information thus generated is transmitted from the drone 10 to the server 30 (S14). The server 30 stores the alighting information received in the alighting information DB 311 (S15). On the other hand, when the drone 10 detects that the user leaves or exits from the doorway 100A of the store 100, the drone 10 takes an image of the exiting user and generates exit information (S16). The exit information generated is transmitted from the drone 10 to the server 30 (S17). The server 30 that has received the exit information compares the exit information with the alighting information stored in the alighting information DB 311, and specifies the first parking slot 111A where the exiting user has parked (S18).

The server 30, which has specified the first parking slot 111A, generates a flight command (S19). This flight command includes, for example, flying to the first parking slot 111A, hovering above the first parking slot 111A, and illuminating the first parking slot 111A with a light. The flight command thus generated is transmitted from the server 30 to the drone 10 (S20). The drone 10, which has received the flight command, flies to the first parking slot 111A in accordance with the flight command, and performs the processing included in the flight command above the first parking slot 111A.

In addition, the server 30 generates first parking slot information based on the information about the first parking slot 111A specified. The first parking slot information is information to be transmitted to the second user terminal 20B for enabling the second user to specify the first parking slot 111A. Note that the first parking slot information may be information to be transmitted to the second vehicle 40B. The first parking slot information generated is transmitted from the server 30 to the user terminal 20 (S23). In the second user terminal 20B that has received the first parking slot information, information capable of specifying the first parking slot 111A included in the first parking slot information is displayed on the display 25 (S24). Also, note that when the second vehicle 40B receives the first parking slot information, the information is displayed on the display 45 of the second vehicle 40B.

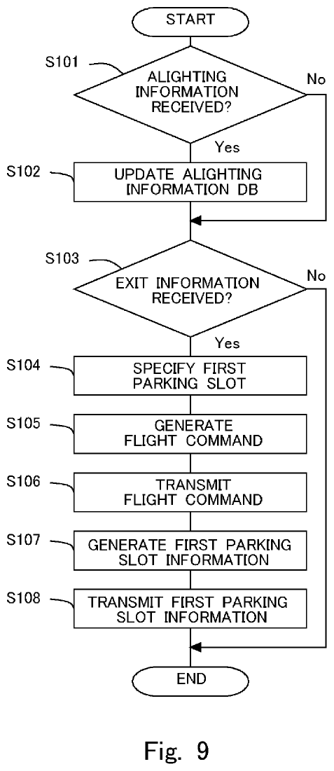

Next, the processing in the server 30 will be described. FIG. 9 is a flowchart of processing in the server 30 according to the present embodiment. The processing illustrated in FIG. 9 is executed at predetermined time intervals in the server 30. Note that in the following description, it is assumed that the server 30 separately receives parking waiting information from the second user terminal 20B.

In step S101, the obtaining unit 301 determines whether or not alighting information is received from the drone 10. When an affirmative determination is made in step S101, the processing proceeds to step S102, whereas when a negative determination is made, the processing proceeds to step S103. In step S102, the obtaining unit 301 updates the alighting information DB 311 by storing the received alighting information in the alighting information DB 311.

In step S103, the obtaining unit 301 determines whether or not exit information has been received from the drone 10. When an affirmative determination is made in step S103, the processing proceeds to step S104, whereas when a negative determination is made, this routine is ended.

In step S104, the command unit 302 specifies the first parking slot 111A. The command unit 302 compares the face image included in the received exit information with the face images stored in the alighting information DB 311, and specifies the first parking slot 111A corresponding to a matching record.

In step S105, the command unit 302 generates a flight command. The flight command is generated such that the drone 10 moves to the first parking slot 111A, and hovers over the first parking slot 111A if it is daytime, or illuminates the first parking slot 111A with a light while hovering over the first parking slot 111A if it is nighttime. The flight command includes information about the position of the first parking slot 111A. In this way, the first user who has left the store 100 and the second user who is waiting to park can be informed of the position of the first parking slot 111A. Then, in step S106, the command unit 302 transmits the flight command to the drone 10.

In step S107, the command unit 302 generates first parking slot information. The first parking slot information includes information capable of specifying the position of the first parking slot 111A. Then, in step S108, the command unit 302 transmits the first parking slot information to the second user terminal 20B. Here, note that in cases where there are a plurality of second vehicles 40B waiting to park, for example, the first parking slot information may be transmitted to these second vehicles 40B in the order in which a plurality of pieces of parking waiting information were transmitted therefrom.

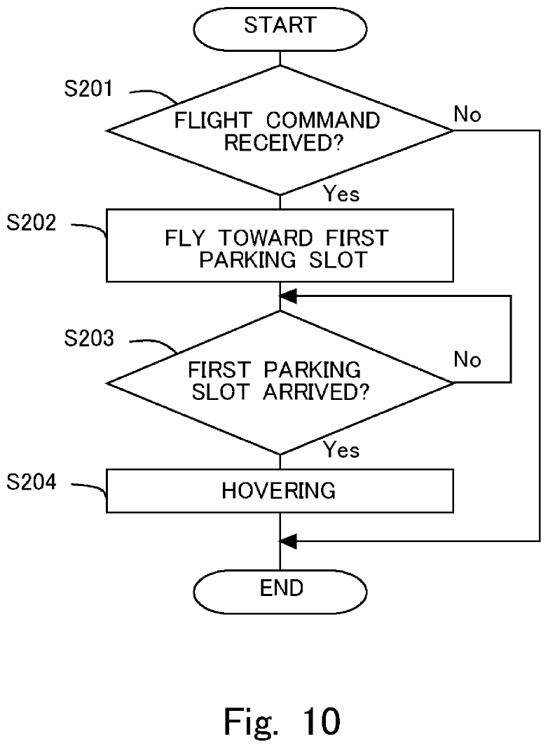

Next, processing of guiding a second vehicle 40B by the drone 10 will be described. FIG. 10 is a flowchart of the processing of guiding the second vehicle 40B by the drone 10 according to the present embodiment. The processing illustrated in FIG. 10 is executed at predetermined time intervals in the drone 10.

In step S201, the control unit 101 determines whether or not a flight command has been received from the server 30. When an affirmative determination is made in step S201, the processing or routine proceeds to step S202, whereas when a negative determination is made, this routine is ended. In step S202, the control unit 101 generates a control command in accordance with the flight command and causes the drone 10 to fly toward the first parking slot 111A. At this time, the control unit 101 controls the drive unit 18 thereby to perform flight control.

In step S203, the control unit 101 determines whether the drone 10 has arrived at the first parking slot 111A. For example, the control unit 101 determines whether or not the drone 10 has arrived at the first parking slot 111A, by comparing the position information obtained by the position information sensor 16 with the position information of the first parking slot 111A obtained from the server 30. When an affirmative determination is made in step S203, the processing proceeds to step S204, whereas when a negative determination is made, the processing of step S203 is executed again.

In step S204, the control unit 101 causes the drone 10 to hover over the first parking slot 111A. When the drone 10 is hovering, the first vehicle 40A moves from the first parking slot 111A, and the second vehicle 40B parks in the first parking slot 111A. Thereafter, this routine ends.

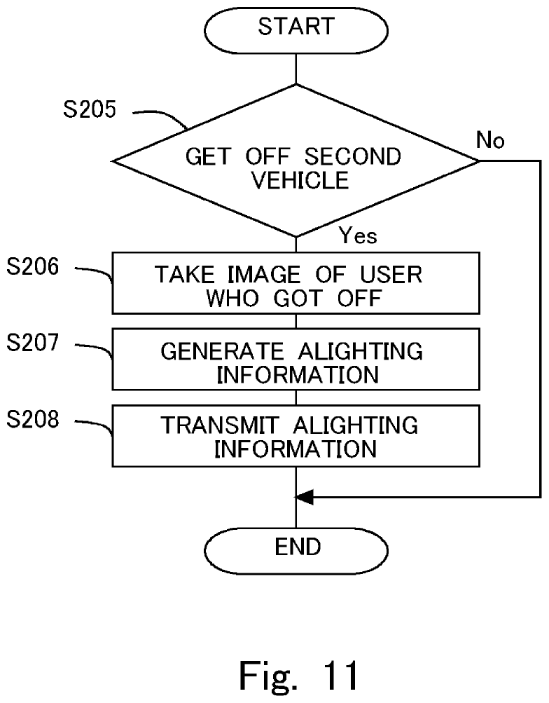

Next, processing of generating alighting information in the drone 10 will be described. FIG. 11 is a flowchart of the processing of generating alighting information in the drone 10 according to the present embodiment. The processing illustrated in FIG. 11 is executed at predetermined time intervals in the drone 10.

In step S205, the control unit 101 determines whether or not the user has gotten off the second vehicle 40B newly parked in the first parking slot 111A. For example, by analyzing the images taken by the camera 15, the control unit 101 determines whether or not the second user has gotten off the second vehicle 40B. Note that when the second vehicle 40B is parked, this vehicle 40 becomes a first vehicle 40A, and when the second user gets off the vehicle, this user becomes a first user. When an affirmative determination is made in step S205, the processing proceeds to step S206, whereas when a negative determination is made, the processing of step S205 is executed again.

In step S206, the control unit 101 causes the camera 15 to take an image of the face of the user who has gotten off the vehicle. Then, in step S207, the control unit 101 generates alighting information. This alighting information includes the image of the user's face taken in step S206 and the position information of the first parking slot 111A. Then, in step S208, the control unit 101 transmits exit information to the server 30.

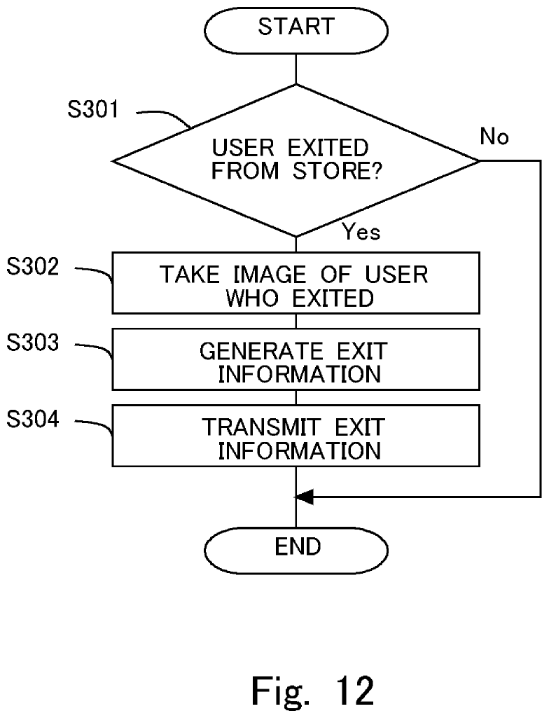

Next, processing of generating exit information in the drone 10 will be described. FIG. 12 is a flowchart of the processing of generating exit information in the drone 10 according to the present embodiment. The processing illustrated in FIG. 12 is executed at predetermined time intervals in the drone 10. Here, note that the processing illustrated in FIG. 12 is executed when the processing illustrated in FIGS. 10 and 11 is not executed. The processing of FIGS. 10, 11 and 12 may be executed by drones 10 that are different from one another.

In step S301, the control unit 101 determines whether or not the user has left (exited) from the doorway 100A of the store 100. For example, by analyzing the image taken by the camera 15, the control unit 101 determines whether or not the user has exited the store 100 from the doorway 100A. The user to be taken by the camera 15 is not limited to the parked user. When an affirmative determination is made in step S301, the processing proceeds to step S302, whereas when a negative determination is made, this routine is ended.

In step S302, the control unit 101 causes the camera 15 to take an image of the face of the user who has gotten off the vehicle. Then, in step S303, the control unit 101 generates exit information. This exit information includes the image of the user's face taken in step S302. Then, in step S304, the control unit 101 transmits the exit information to the server 30.

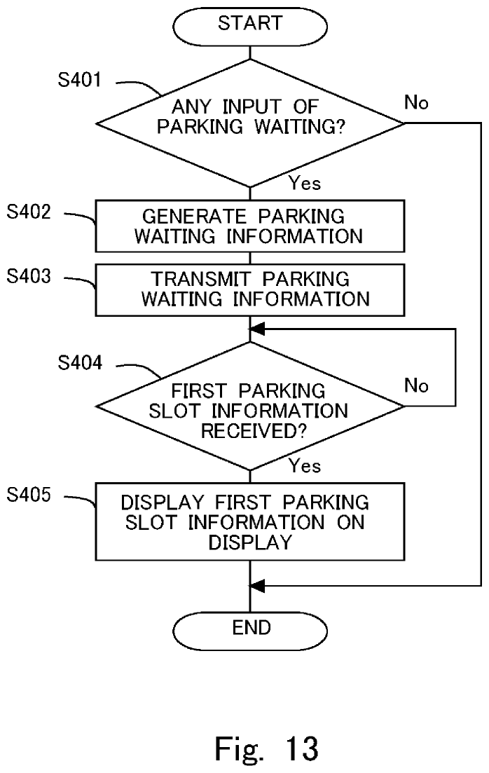

Next, processing in the user terminal 20 will be described. FIG. 13 is a flowchart of the processing in the user terminal 20 according to the present embodiment. The processing illustrated in FIG. 13 is executed at each predetermined time interval in the user terminal 20.

In step S401, the control unit 201 determines whether or not the input unit 24 has received an input indicating a parking waiting state. For example, an application for notifying a parking lot slot is installed in the user terminal 20, and a button for entering or inputting a parking lot waiting state is displayed on the display 25 by the application. When the user presses the button, the control unit 201 determines that the input unit 24 has received an input indicating a parking waiting state. Note that, as another method, for example, in cases where it is predicted that the vehicle 40 will enter a parking lot 110, the control unit 201 may determine that there is an input indicating a parking waiting state in the input unit 24. The case where it is predicted that the vehicle 40 will enter the parking lot 110 is, for example, a case where it is determined, based on the position information of the user terminal 20 and the map information, that the vehicle 40 is traveling in a lane that leads to the parking lot 110. Also, for example, it may be a case where the vehicle 40 has passed through the entrance of the parking lot 110, based on the position information of the user terminal 20 and the map information. The map information has been stored in the auxiliary storage unit 23. When an affirmative determination is made in step S401, the processing proceeds to step S402, whereas when a negative determination is made, this routine is ended.

In step S402, the control unit 201 generates parking waiting information. The parking waiting information includes a user ID and position information. The position information may be the position information of the user terminal 20 or the position information of the parking lot 110 in which the user is predicted to park. Then, in step S403, the control unit 201 transmits the parking waiting information to the server 30.

In step S404, the control unit 201 determines whether or not the first parking slot information has been received from the server 30. When an affirmative determination is made in step S404, the processing proceeds to step S405, whereas when a negative determination is made, the processing of step S404 is executed again. In step S405, the control unit 201 outputs to the display 25 according to the first parking slot information. The control unit 201, for example, displays a map indicating the position of the first parking slot 111A on the display 25.

As described above, according to the present embodiment, it is possible to park a parking waiting vehicle 40 in a parking slot 110A more quickly, by specifying the parking slot that is predicted to become vacant in the near future based on an image of the face of a user who has left (exited) the store 100, and informing a first user who has parked and a second user who is waiting to park of the place or location of the parking slot specified. Thus, the time spent in waiting for parking can be shortened.

### Second Embodiment

In the above-described first embodiment, the drone 10 is used to associate a parking slot 110A with a user who has left a store. On the other hand, in a second embodiment, the association between a parking slot 110A and a user who has left a store is performed by a user terminal 20. Therefore, in the second embodiment, the drone 10 is not necessarily required.

In order to associate a user terminal 20 with a parking slot 110A, when a user parks a vehicle 40 in the parking slot 110A, for example, the user enters the number of the parking slot 110A indicated in the parking slot 110A into the user terminal 20. Then, the user ID of the user (or user terminal) and the number of the parking slot 110A are transmitted from the user terminal 20 to the server 30. Thus, the user terminal 20 and the parking slot 110A are associated with each other.

Moreover, for example, it is also possible to associate the user terminal 20 with the parking slot 110A by using the position information of the user terminal 20. For example, wireless communication between the user terminal 20 and the vehicle 40 can be used to detect that the user terminal 20 has left the vehicle 40. That is, since it is possible to detect that the user has gotten off the vehicle 40 with the user terminal 20, it is possible to associate the user terminal 20 with the parking slot 110A by considering the position where the user has gotten off the vehicle 40 as the position of the parking slot 110A. Here, it may be the vehicle 40 or the user terminal 20 that transmits to the server 30 information indicating that it has been detected that the user terminal 20 has left the vehicle 40.

Further, for example, a terminal for performing short-range wireless communication with the user terminal 20 may be provided in each parking slot 110A, and the user terminal 20 and a parking slot 110A may be associated with each other by holding the user terminal 20 over the terminal in the parking slot 110A after the user has parked in the parking slot 110A. In this case, the position information of the parking slot 110A is transmitted from the terminal of the parking slot 110A to the user terminal 20, and further, the user ID and the position information of the parking slot 110A are associated with each other and transmitted from the user terminal 20 to the server 30. Also, as an alternative method, the user ID and the position information of the parking slot 110A may be associated with each other and transmitted to the server 30 from the terminal of the parking slot 110A that received the user ID from the user terminal 20.

Here, note that the terminal, which performs short-range wireless communication with the user terminal 20, may also be, for example, a terminal dedicated to specifying the parking slot 110A, but other than this, it may be another terminal, for example, to pay a fee to a charging station for an electric vehicle. That is, when a fee is paid by using the user terminal 20, the user terminal 20 may be associated with the parking slot 110A. When a payment is made by using a credit card instead of the user terminal 20, the credit card may be associated with the parking slot 110A.

Then, based on the information obtained by the user terminal 20, the user who leaves or exits the store 100 is specified. For example, in cases where a terminal for short-range wireless communication with the user terminal 20 is arranged near a cash register, and when short-range wireless communication is made between the terminal near the cash register and the user terminal 20, it can be predicted that the user corresponding to the user terminal leaves the store 100. Also, for example, in cases where a terminal for short-range wireless communication is arranged in the doorway 100A of the store 100, and when short-range wireless communication is made twice between the terminal set in the doorway 100A of the store 100 and the user terminal 20, it can be predicted that the user corresponding to the user terminal 20 leaves the store 100. Note that the reason why the short-range wireless communication is made twice is that the first one is considered to be a communication associated with entering the store. Also, a terminal for short-range wireless communication may be arranged not only in the doorway 100A of the store 100 but also in a passage between the store 100 and the parking lot 110. As an alternative, when the user uses a credit card at a cash register, it may be predicted that the user will leave the store.

In addition, the user who leaves the store 100 may be specified based on the position information of the user terminal 20. For example, when the position information of the user terminal 20 indicates that the user terminal 20 passes through the doorway 100A from the inside of the store 100, it can be predicted that the user corresponding to the user terminal 20 leaves the store.

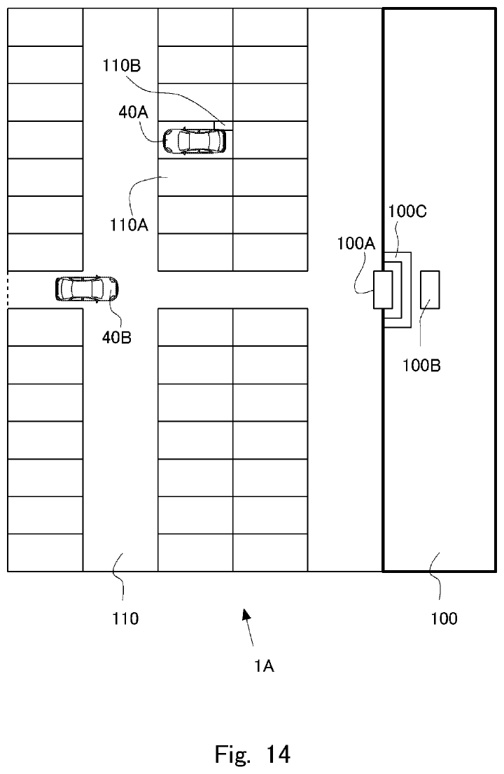

FIG. 14 is a view illustrating an outline of the store 100 and the parking lot 110 according to the second embodiment. Differences of FIG. 14 from FIG. 2 will be mainly described. A first payment machine 110B is arranged in each parking slot 110A. The first payment machine 110B is, for example, a device used to pay for charging an electric vehicle in the parking slot 110A. A second payment machine 100B is arranged in the store 100. The second payment machine 100B is a device used to pay for purchases made in the store 100. The first payment machine 110B and the second payment machine 100B, for example, read a two-dimensional code displayed on the user terminal 20, and withdraw fees from a credit card or a bank account associated with the two-dimensional code. A gate 100C is provided at the doorway 100A of the store 100, and this gate 100C can detect the user terminal 20 that has passed through the doorway 100A by performing short-range wireless communication with the user terminal 20. Note that at least one of the second payment machine 100B and the gate 100C may be provided. Also, note that the first payment machine 110B is an example of a first transmission unit, and the second payment machine 100B is an example of a second transmission unit.

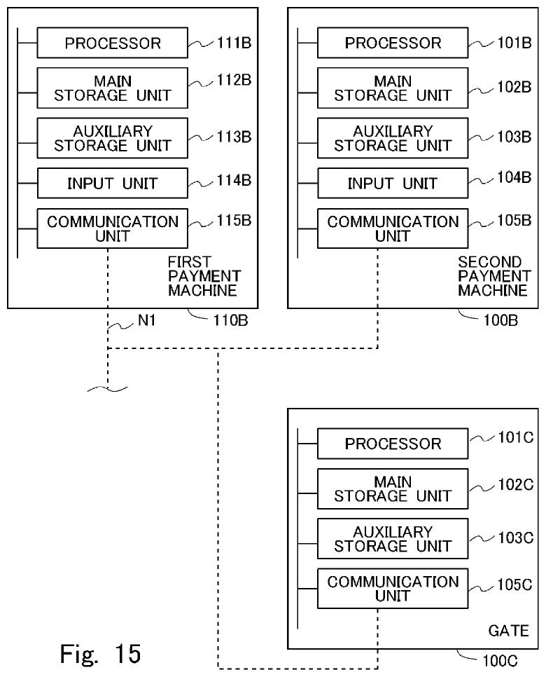

FIG. 15 is a block diagram schematically illustrating an example of a configuration of each of the first payment machine 110B, the second payment machine 100B, and the gate 100C, which together constitute a system 1A according to the second embodiment.

The first payment machine 110B includes a processor 111B, a main storage unit 112B, an auxiliary storage unit 113B, an input unit 114B, and a communication unit 115B. These components are connected to one another by means of a bus. The processor 111B, the main storage unit 112B, the auxiliary storage unit 113B, and the communication unit 115B are the same as the processor 11, the main storage unit 12, the auxiliary storage unit 13, and the communication unit 14 of the drone 10 described in the first embodiment, respectively, and thus the description thereof will be omitted. The input unit 114B is a means or unit for reading a bar code or a two-dimensional code. The input unit 114B may be, for example, an imaging device using an image sensor such as a charge-coupled device (CCD), a metal oxide semiconductor (MOS), a complementary metal oxide semiconductor (CMOS) or the like.

The second payment machine 100B includes a processor 101B, a main storage unit 102B, an auxiliary storage unit 103B, an input unit 104B, and a communication unit 105B. These components are connected to one another by means of a bus. The processor 101B, the main storage unit 102B, the auxiliary storage unit 103B, the input unit 104B, and the communication unit 105B of the second payment machine 100B are the same as the processor 111B, the main storage unit 112B, the auxiliary storage unit 113B, the input unit 114B, and the communication unit 115B of the first payment machine 110B, respectively, and thus the description thereof will be omitted.

The gate 100C includes a processor 101C, a main storage unit 102C, an auxiliary storage unit 103C, and a communication unit 105C. These components are connected to one another by means of a bus. The processor 101C, the main storage unit 102C, the auxiliary storage unit 103C, and the communication unit 105C of the gate 100C are the same as the processor 111B, the main storage unit 112B, the auxiliary storage unit 113B, and the communication unit 115B of the first payment machine 110B, and hence the description thereof will be omitted.

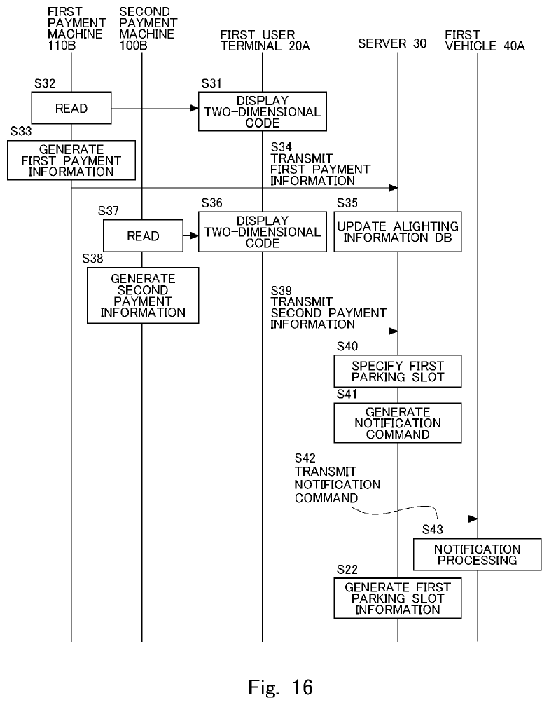

Next, the processing of the system 1A as a whole will be described. FIG. 16 is a sequence diagram of the processing of the system 1A. The same processing as in the sequence diagram illustrated in FIG. 8 will be denoted by the same reference signs, and the description thereof will be omitted. The processing in the second user terminal 20B is the same as in FIG. 8, and hence the illustration and description thereof will be omitted. In FIG. 16, after the first vehicle 40A is parked in the first parking slot 111A, a two-dimensional code is displayed on the first user terminal 20A for payment in the first payment machine 110B (S31). In order to display the two-dimensional code, the first user makes a predetermined input to the input unit 24.

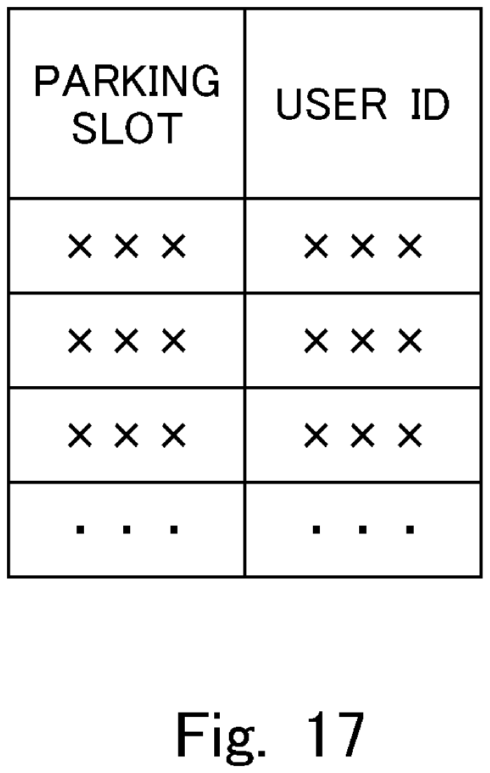

The two-dimensional code displayed on the first user terminal 20A is read into the first payment machine 110B (S32). Then, the first payment machine 110B makes the payment and generates first payment information (S33). The first payment information is information that associates the first parking slot 111A with the first user terminal 20A. The first payment information is transmitted from the first payment machine 110B to the server 30 (S34). The server 30 stores the first payment information received in the alighting information DB 311 (S35). Here, FIG. 17 is a diagram illustrating an example of a table structure of the alighting information DB 311 according to the second embodiment. The alighting information table includes each field for parking slot and user ID. The parking slot field is a field in which information capable of specifying the position of each parking slot is entered. In the parking slot field, for example, the position information of the first parking slot 111A transmitted from the first payment machine 110B is entered. The user ID field is a field in which identification information of the first user terminal 20A is entered. The identification information of the first user terminal 20A is obtained based on the two-dimensional code displayed on the first user terminal 20A.

Moreover, in FIG. 16, a two-dimensional code is displayed on the first user terminal 20A in order for the user to make a payment in the second payment machine 100B when the user shops in the store 100 (S36). The two-dimensional code displayed on the first user terminal 20A is read into the second payment machine 100B (S37). Then, the second payment machine 100B makes the payment and generates second payment information (S38). The second payment information is information for specifying the first user terminal 20A carried by the user who leaves or exits the store, and includes, for example, the user ID. The second payment information is transmitted from the second payment machine 100B to the server 30 (S39). The server 30, which has received the second payment information, compares the information stored in the alighting information DB 311 with the second payment information, and specifies the first parking slot 111A where the user who left the store has parked (S40).

Further, in the server 30, when the first parking slot 111A is specified, a notification command is generated (S41). The notification command is a command for causing a vehicle 40 to notify its own position. As a means for causing the vehicle 40 to notify its own position, for example, a hazard lamp or a headlight may be caused to blink, or a horn may be caused to sound. The notification command thus generated is transmitted from the server 30 to the first vehicle 40A (S42). In the first vehicle 40A that has received the notification command, notification processing is executed (S43). The notification processing is processing for causing a vehicle 40 to notify its own position. By executing the notification processing, for example, a hazard lamp or a light is blinked or a horn is sounded. This makes it easier for the first user to find the first vehicle 40A.

The processing after the server 30 generates the first parking slot information (after S22) is the same as in FIG. 8.

Here, note that, as an alternative method, the first payment information and the second payment information may be generated by the first user terminal 20A and transmitted to the server 30. For example, when the payment of the first user terminal 20A is completed in the first payment machine 110B, information indicating that the payment is completed may be transmitted from the first payment machine 110B to the first user terminal 20A in association with the first parking slot 111A. Then, at the first user terminal 20A, first payment information, which includes information indicating that the payment has been completed, the first parking slot 111A and the user ID, may be generated and transmitted to the server 30.

In addition, when the payment of the first user terminal 20A is completed in the second payment machine 100B, information indicating that the payment is completed may be transmitted from the second payment machine 100B to the first user terminal 20A. The first user terminal 20A may generate second payment information, which is information including information indicating that the payment is completed and the user ID, and transmit it to the server 30.

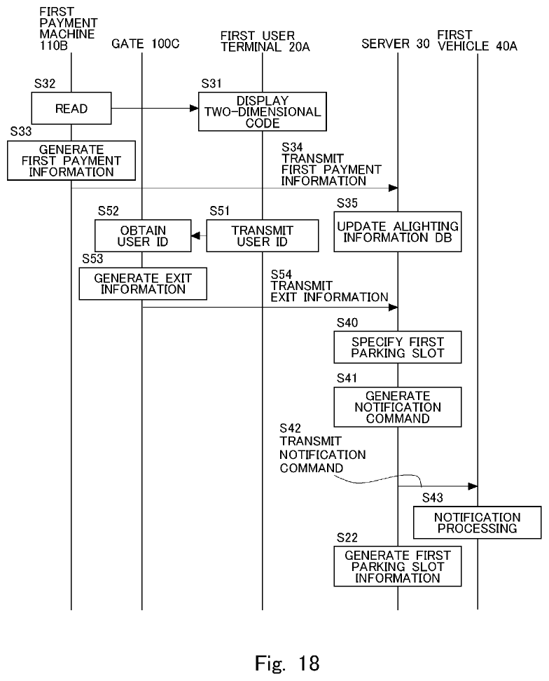

Further, a description will be given of the processing of the entire system 1A in the case where exit information is generated in the gate 100C, instead of generating the second payment information in the second payment machine 100B. FIG. 18 is a sequence diagram of the processing of the system 1A. The same processing as in the sequence diagram illustrated in FIG. 8 or FIG. 16 will be denoted by the same reference signs, and the description thereof will be omitted. In FIG. 18, when the user passes through the gate 100C upon leaving the store 100, communication is performed between the first user terminal 20A and the gate 100C. In this communication, the user ID is transmitted from the first user terminal 20A to the gate 100C (S51). When the gate 100C obtains the user ID, it is determined whether or not the obtaining of the user ID is the second time in the gate 100C. Note that, as an alternative method, the direction of movement of the first user terminal 20A may be estimated, and it may be determined whether or not the first user terminal 20A is moving in the direction of the parking lot 110. Then, when the user ID is obtained for the second time, or when the first user terminal 20A is moving in the direction of the parking lot 110, exit information is generated at the gate 100C (S53). The exit information is information including the user ID of the user who leaves the store. The exit information thus generated is transmitted to the server 30 (S54).

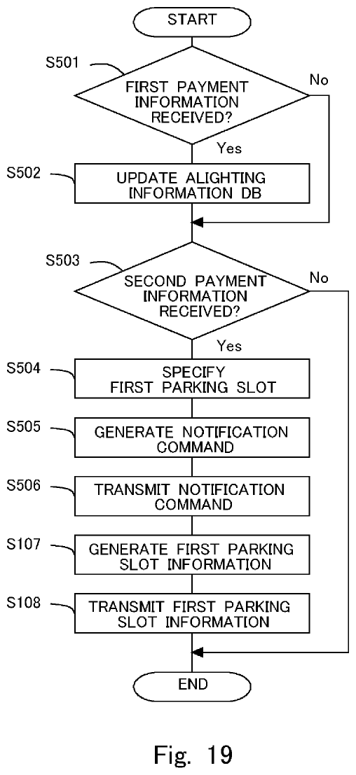

Then, the processing in the server 30 will be described. FIG. 19 is a flowchart of processing in the server 30 according to the second embodiment. The processing illustrated in FIG. 19 is executed at predetermined time intervals in the server 30. Here, note that steps in which the same processing as in FIG. 9 is executed will be denoted by the same reference signs, and the description thereof will be omitted.

In step S501, the obtaining unit 301 determines whether or not the first payment information has been received from the first payment machine 110B. When an affirmative determination is made in step S501, the processing proceeds to step S502, whereas when a negative determination is made, the processing proceeds to step S503. In step S502, the obtaining unit 301 updates the alighting information DB 311 by storing the first payment information received in the alighting information DB 311.

In step S503, the obtaining unit 301 determines whether or not the second payment information has been received from the second payment machine 100B. When an affirmative determination is made in step S503, the processing proceeds to step S504, whereas when a negative determination is made, this routine is ended.

In step S504, the command unit 302 specifies the first parking slot 111A. The command unit 302 compares the user ID included in the received second payment information with the user IDs stored in the alighting information DB 311, and specifies the first parking slot 111A corresponding to the matching user ID.

In step S505, the command unit 302 generates a notification command. The notification command is generated such that the vehicle 40 blinks a hazard lamp or a headlight, or sounds a horn. Note that, as another method, for example, a lamp may be provided for each parking slot 110A, and the notification command may be generated so as to turn on the lamp of a parking slot 110A. The notification command is transmitted to a controller that controls the lamp. In this manner, the position of the first parking slot 111A can be notified to the first user who has left the store 100. Then, in step S506, the command unit 302 transmits the notification command to the first vehicle 40A.

Here, note that in the second embodiment, the first payment information and the second payment information are generated when the payments are made by the user terminal 20, but as an alternative method, the first payment information and the second payment information may be generated when the payments are made by a credit card. For example, the first parking slot 111A may be specified by associating a credit card number with the first parking slot 111A and further by obtaining the credit card number owned by the first user who is leaving the store.

In addition, in the second embodiment, the first payment information and the second payment information are generated when the payments are made at the user terminal 20, but as an alternative method, for example, a terminal (referred to as a parking slot terminal) configured to perform short-range wireless communication with the user terminal 20 may be provided in each parking slot 110A, and the user terminal 20 or the user ID may be associated with the parking slot 110A by having the user hold the user terminal 20 over the parking slot terminal. Similarly, for example, a terminal (referred to as a doorway terminal) configured to perform short-range wireless communication with the user terminal 20 may be provided at the doorway 100A of the store 100, and when the user leaves the store, the user terminal 20 or user ID of the user leaving the store may be specified by holding the user terminal 20 over the doorway terminal.

As described above, according to the second embodiment, when the first user leaves the store, the first parking slot 111A associated with the first user terminal 20A can be specified. Accordingly, it is possible to specify the parking slot that is predicted to become vacant in the near future and notify the first user who has parked and the second user who is waiting to park of the location thereof. As a result, the second vehicle 40B waiting for parking can be parked in the parking slot 110A more quickly. Thus, the time spent in waiting for parking can be shortened.

### Third Embodiment

In the above-described first embodiment, the drone 10 is used to associate a parking slot 110A with a user who has left a store. On the other hand, in a system 1B according to a third embodiment, a transmitter and a receiver provided in a parking slot 110A are used to associate the parking slot 110A with a user and to specify a user who has left a store. Therefore, in the third embodiment, the drone 10 is not necessarily required.

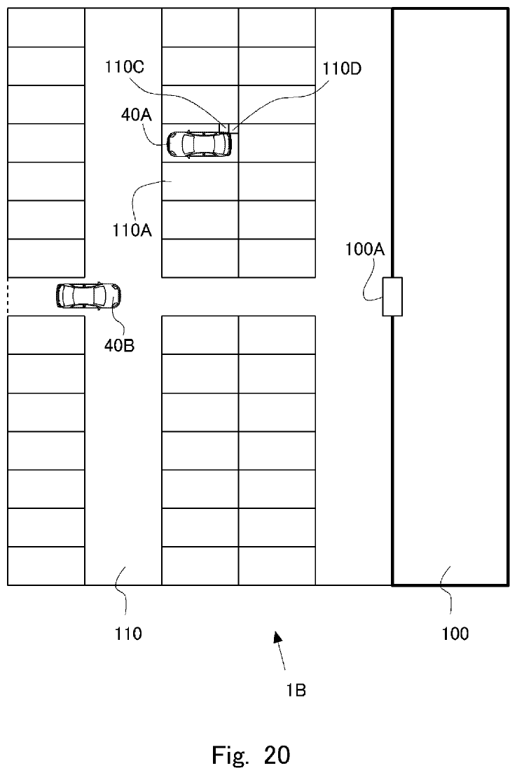

In the third embodiment, the position information of a user is obtained by using, for example, a BLE (Bluetooth (registered trademark) Low Energy) beacon. FIG. 20 is a view illustrating an outline of a store 100 and a parking lot 110 according to the third embodiment. Differences of FIG. 20 from FIG. 2 will be mainly described. Each parking slot 110A is provided with a transmitter 110C and a receiver 110D of a beacon. A transmitter 110C can be carried by a user. A radio wave transmitted from a transmitter 110C is received by a receiver 110D to specify the position of the transmitter 110C. Note that the position of each receiver 110D is not limited to the position illustrated in FIG. 20. In addition, a receiver 110D may respond to a plurality of transmitters 110C. Also, a plurality of receivers 110C may respond to one transmitter 110D. Note that the transmitter 110C is an example of a first transmitter and a second transmitter.

Receivers 110D transmit the position information of transmitters 110C to the server 30. The server 30 stores, for example, the relationship between parking slots 110A and transmitters 110C in the auxiliary storage unit 33. That is, transmitters 110A are associated with individual parking slots 110C, respectively. When the position of a transmitter 110C starts moving from a parking slot 110A, the server 30 can determine that a user has gotten off a vehicle in the parking slot 110A. In addition, when the position of a transmitter 110C moves from the store 100 to the parking lot 110, the server 30 can determine that the user has left the store.

In this way, by using a beacon, it is also possible to specify a first parking slot 111A where a first user who left or exited the store has parked. Then, by informing the first user who has parked and a second user who is waiting to park of the location or position of the first parking slot 111A, a second vehicle 40B waiting to park can be parked in the parking slot 110A more quickly. Thus, the time spent in waiting for parking can be shortened.

Here, note that in the third embodiment, the beacon is used to specify the position of the first user, but as an alternative method, the reach of the beacon may be set around the parking slot, and when the beacon is no longer detected, it may be detected that the user has parked in the parking slot 110A, and if the beacon subsequently begins to be received, it may be predicted that the user has left the store. In this case, for example, a lamp arranged in the parking slot 110A may be turned on when the user is predicted to leave the store. The server 30 receives, from a receiver of the beacon, the detection of parking and the detection of a sign of leaving the store. That is, when the user moves away from the vehicle beyond the reach of the beacon, it is considered that the user has gotten off the vehicle 40, and thus it can be determined that the vehicle 40 has been parked in the parking slot 110A. In addition, when the user subsequently enters within the reach of the beacon, it is considered that the user has left the store 100 to get into the vehicle 40. With the use of these, it is possible to guide the second user to the parking slot 110A.

### Other Embodiments

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the server 30 may include a part of the functions of the drone 10. Also, for example, the drone 10 may include a part or all of the functions of the server 30.

Moreover, in the above-described embodiments, the drone 10 has been described as an example of the moving object, but instead of this, the present invention can be applied to, for example, a vehicle capable of traveling autonomously.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
obtaining information for associating a parking slot in which a user has parked with the user;
obtaining information about a sign of the user returning to the parking slot; and
making another user waiting to park aware of a position of the parking slot when the user obtains the information about the sign of the user returning to the parking slot.

2. The information processing apparatus according to claim 1, wherein
the controller obtains, as the information for associating the parking slot in which the user has parked with the user, an image taken of the user and position information of the parking slot.

3. The information processing apparatus according to claim 2, wherein
the controller obtains the image taken of the user and the position information of the parking slot from an autonomous moving object.

4. The information processing apparatus according to claim 1, wherein
the controller obtains, as the information for associating the parking slot in which the user has parked with the user, information about a position of a payment machine with which the user has made a payment related to the use of the parking slot.

5. The information processing apparatus according to claim 1, wherein
the controller obtains, as the information for associating the parking slot in which the user has parked with the user, information about a position at which a transmitter associated with the parking slot and carried by the user starts moving.

6. The information processing apparatus according to claim 1, wherein
the controller obtains, as the information about the sign of the user returning to the parking slot, an image taken of the user moving in a direction of the parking slot.

7. The information processing apparatus according to claim 6, wherein
the controller obtains an image taken of the user moving in the direction of the parking slot from an autonomous moving object.

8. The information processing apparatus according to claim 1, wherein
the controller obtains, as the information about the sign of the user returning to the parking slot, information about the user making a payment at a store.

9. The information processing apparatus according to claim 1, wherein
the controller obtains, as the information about the sign of the user returning to the parking slot, information about a position of a transmitter associated with the parking slot and carried by the user.

10. The information processing apparatus according to claim 1, wherein
the controller makes the other user waiting to park aware of the position of the parking slot, by flying an autonomous moving object to the parking slot.

11. The information processing apparatus according to claim 1, wherein
the controller makes the other user waiting to park aware of the position of the parking slot, by turning on a light indicating the position of the parking slot.

12. The information processing apparatus according to claim 1, wherein
the controller makes the other user waiting to park aware of the position of the parking slot, by causing a vehicle to notify a position of the vehicle parked in the parking slot.

13. An information processing method for causing a computer to perform:
obtaining information for associating a parking slot in which a user has parked with the user;
obtaining information about a sign of the user returning to the parking slot; and
making another user waiting to park aware of a position of the parking slot when the user obtains the information about the sign of the user returning to the parking slot.

14. The information processing method according to claim 13, wherein
the computer obtains, as the information for associating the parking slot in which the user has parked with the user, an image taken of the user and position information of the parking slot.

15. The information processing method according to claim 13, wherein
the computer obtains, as the information for associating the parking slot in which the user has parked with the user, information about a position of a payment machine with which the user has made a payment related to the use of the parking slot.

16. The information processing method according to claim 13, wherein
the computer obtains, as the information for associating the parking slot in which the user has parked with the user, information about a position at which a transmitter associated with the parking slot and carried by the user starts moving.

17. The information processing method according to claim 13, wherein
the computer obtains, as the information about the sign of the user returning to the parking slot, an image taken of the user moving in a direction of the parking slot.

18. The information processing method according to claim 13, wherein
the computer obtains, as the information about the sign of the user returning to the parking slot, information about the user making a payment at a store.

19. The information processing method according to claim 13, wherein
the computer obtains, as the information about the sign of the user returning to the parking slot, information about a position of a transmitter associated with the parking slot and carried by the user.

20. A system comprising:
a first transmission unit configured to transmit a parking slot in which a user has parked and the user in association with each other;
a second transmission unit configured to transmit information about a sign of the user returning to the parking slot; and
a controller configured to make another user waiting to park aware of a position of the parking slot based on information received from the first transmission unit and the second transmission unit.
